(19) United States
(12) Patent Application Publication
(10) Pub. No.: US 2012/0301819 A1
(43) Pub. Date: Nov. 29, 2012

(54) TONER HAVING EXCELLENT BLOCKING RESISTANCE AND FLOWABILITY, AND METHOD FOR PRODUCING SAME

(75) Inventors: Dae Woong Choi, Daejeon-city (KR); Jae Bum Park, Daejeon-city (KR); Young Jae Kwon, Daejeon-city (KR)

(73) Assignee: SAMSUNG FINE CHEMICALS CO., LTD., Ulsan (KR)

(21) Appl. No.: 13/574,022

(22) PCT Filed: Feb. 1, 2011
(86) PCT No.: PCT/KR2011/000732

§ 371 Date: Jul. 19, 2012

(30) Foreign Application Priority Data
Feb. 5, 2010 (KR) 10-2010-0011175

(51) Int. Cl. G03G 9/087; G03G 13/16

(52) U.S. Cl. 430/108.6; 430/109.1; 430/125.3

(57) ABSTRACT

Provided is a toner having excellent blocking resistance and flowability. The toner comprises a binder resin, a releasing agent, a colorant and an external additive, wherein the toner particles satisfy expression (1):

2.0≦RD/TD≦2.5 (1),

where RD is the real density of the toner particles and TD is the tap density of the toner particles.

### TECHNICAL FIELD

One or more embodiments of the present invention relate to toner particles for developing an electrostatic charge image, a developer for forming an electrophotographic image which includes the toner particles, and a method of forming an electrophotographic image by using the developer, and more particularly, to toner particles having excellent blocking resistance and flowability, a developer for forming an electrophotographic image which includes the toner particles, and a method of forming an electrophotographic image by using the developer.

### BACKGROUND ART

Conventionally, there are many well known electrophotographic methods. According to the electrophotographic methods, an electrostatic latent image is formed on a photosensitive member by various means using an optical conductive material, the electrostatic latent image is developed by toner to form a toner image, and the toner image is transferred to an image receiving member, such as paper and then fixed thereon by applying heat and/or pressure, thereby forming an image.

Examples of an image forming apparatus using the electrophotographic method include printers, copy machines, and facsimile machines. These image forming apparatuses require a developing method that can exhibit high resolution and definition, and according to the demand, a toner suitable for the developing method is being developed.

Recently, there has been an increasing demand from the printing market for a toner that is unlikely to have a blocking phenomenon in spite of the use thereof for long period of time, and has excellent flowability and thus prevents image defects due to scattering of toner particles.

### DETAILED DESCRIPTION OF THE INVENTION

### Technical Problem

The present invention provides toner particles having excellent blocking resistance and flowability.

The present invention also provides a developer for forming an electrostatic charge image which includes the toner particles.

The present invention also provides a method of forming an electrophotographic image by using the developer.

### Technical Solution

According to an aspect of the present invention, toner particles for developing an electrostatic charge image include a binder resin, a releasing agent, a colorant, and an external additive, wherein the toner particles satisfy expression (1):

2.0≦RD/TD2.5 (1),

wherein RD is the real density of the toner particles and TD is the tap density of the toner particles.

The toner particles may have a TD of 0.43 to 0.55 g/cm³.

An amount of the external additive may be in a range of 0.1 to 3.0 wt %.

According to another aspect of the present invention, a developer for forming an electrostatic charge image includes the toner particles described above.

According to another aspect of the present invention, a method of forming an electrophotographic image includes adhering the toner particles to a surface of a photosensitizer on which an electrostatic latent image is formed to form a toner image and transferring the toner image to a transfer member.

### ADVANTAGEOUS EFFECTS

Toner particles according to one or more embodiments of the present invention have excellent blocking resistance and flowability, whereby excellent image quality is obtained even after the use thereof for long period of time, and contamination and scattering of the toner particles are suppressed.

### MODE OF THE INVENTION

Hereinafter, exemplary embodiments of the present invention will be described in detail.

According to an embodiment of the present invention, toner particles include a binder resin, a releasing agent, a colorant, and an external additive, wherein the toner particles satisfy expression (1):

2.0≦RD/TD2.5 (1)

wherein RD is the real density of the toner particles and TD is the tap density of the toner particles.

The TD of the toner particles is a value obtained as described below by using a bulk density measuring device by tapping. That is, 10 g of a toner sample after external addition is loaded on a sieve having an aperture of 355 μm, and tapping is performed thereon at a rate of 1.67 times/sec. After the tapping process, the volume (cm³) of the toner included in a 150 ml vessel is measured to obtain the TD of the toner particles.

The RD of the toner particles may be measured using a real density measuring device such as a pycnometer. For example, the RD of the toner particles is measured five times for each sample by using a gas type pycnometer (AccuPyc II 1340, Micrometrics USA), and is obtained as an average value of the obtained RD values.

When the ratio of RD/TD is less than 2.0, the flowability of the toner particles is too high, so that the toner particles may be leaked from a toner cartridge, resulting in poor packaging of the toner. When the ratio of RD/TD is greater than 2.5, blocking of the toner particles may occur severely, resulting in poor image quality.

In one embodiment, the toner particles may have a TD of 0.43 to 0.55g/cm³. When the TD of the toner particles is within these ranges, the toner particles are advantageous for no blocking and excellent flowability.

The binder resin included in the toner particles may be prepared by polymerizing at least one polymerizable monomer selected from the group consisting of a vinyl-based monomer, a carboxyl group-containing polar monomer, an ester group-containing monomer, and a fatty acid group-containing monomer. Examples of the polymerizable monomer include, but are not limited to, a styrene-based monomer selected from styrene, vinyltoluene, and a-methylstyrene; acrylic acid, methacrylic acid; a (meth)acrylic acid derivative selected from methyl acrylate, ethyl acrylate, propyl acrylate, butyl acrylate, 2-ethylhexyl acrylate, di methylaminoethyl acrylate, methyl methacrylate, ethyl methacrylate, propyl methacrylate, butyl methacrylate, 2-ethylhexyl methacrylate, dimethylaminoethyl methacrylate, acrylonitrile, methacrylonitrile, acrylamide, and methacrylamide; an ethylenically unsaturated monoolefin selected from ethylene, propylene, and butylene; halogenated vinyl selected from vinyl chloride, vinylidene chloride, and vinyl fluoride; vinylester selected from vinyl acetate and vinyl propionate; vinylether selected from vinylmethylether and vinylethylether; vinylketone selected from vinylmethylketone and methylisopropenylketone; and a nitrogen-containing vinyl compound selected from 2-vinylpyridine, 4-vinylpyridine, and N-vinylpyrrolidone.

To initiate the polymerizing process, an aqueous polymerization initiator may be generally used. Examples of the aqueous polymerization initiator include ammonium persulfate (APS) and potassium persulfate (KPS).

Some of the binder reins may be selected and further react with a cross-linking agent. Examples of the cross-linking agent include an isocyanate compound and an epoxy compound.

The colorant included in the toner particles may be used in the form of a pigment itself, or in the form of a pigment master batch in which the pigment is dispersed in a resin.

The pigment may be appropriately selected from black pigment, cyan pigment, magenta pigment, yellow pigment, and mixtures thereof, which are commercially used pigments.

The amount of the colorant may be an amount sufficient to color the toner and form a visible image by developing. For example, the amount of the colorant may be in the range of 1 to 20 parts by weight based on 100 parts by weight of the binder resin.

The releasing agent may be a wax that improves fixability of a toner image. Examples of the wax include a polyalkylene wax such as a low molecular weight polypropylene wax and a low molecular weight polyethylene wax, an ester wax, a carnauba wax, and a paraffin wax. The amount of the wax included in the toner particles may be generally in the range of 0.1 wt % to 30 wt % based on the total weight of the toner particles. When the amount of the wax is less than 0.1 wt % based on the total weight of the toner particles, it is difficult to perform oil-less fixing whereby toner particles may be fixed without using oil. On the other hand, when the amount of the wax is greater than 30 wt % based on the total weight of the toner particles, it may cause agglomeration of the toner during storage.

The external additive improves flowability and chargeability of the toner particles, and may be, for example, small particle-sized silica, large particle-sized silica, titanium oxide, and a polymer bead. Particularly, the external additive may include small particle-sized silica and titanium oxide.

The amount of the external additive may be in the range of 0.1 wt % to 3.0 wt %. The external additive may have a BET surface area of 30 m²/g to 230 m²/g.

The toner particles may be prepared using one of various methods that are used in the art, and the preparation method is not particularly limited as long as it is suitable for use in preparing toner particles having the physical properties described above.

For example, the toner particles may be prepared using the following method. The toner particles are prepared by adding an agglomerating agent to a mixture of a latex, a colorant dispersion, and a wax dispersion and homogenizing and aggregating the resultant mixture. That is, the aggregating process is performed by adding the latex, the colorant dispersion, and the wax dispersion to a reactor, mixing them together, adding the agglomerating agent thereto, homogenizing the resulting mixture by using a high-speed homogenizer (Cavitron) at pH of 1.5 to 2.3 and a temperature of 20 to 30° C. for 10 to 100 minutes, raising the temperature of the reactor from 30° C. to 53° C., stirring the resultant mixture at a linear velocity of 1.0 to 2.5 m/s, and further stirring the resultant mixture at a linear velocity of 1.0 to 2.5 m/s, a pH of 1.5 to 2.3 and a temperature of 50° C. to 55° C. for 2 to 6 hours. The aggregated toner particles are subjected to fusing, cooling and drying processes, thereby obtaining desired toner particles.

The toner particles may have a core-shell structure. The toner having the core-shell structure may be prepared by adding an agglomerating agent to a mixture of a latex for core, a colorant dispersion, and a wax dispersion, homogenizing and aggregating the resultant mixture, adding a latex for shell thereto after the aggregating process is completed, to form a shell. In this regard, after the formation of the shell, pH of the resulting mixture is adjusted to 5.0 to 8.0 by adding 4% NaOH thereto, thereby terminating the action of the agglomerating agent. After the addition of 4% NaOH, a second heating process is performed to raise the temperature of the resultant up to a fusing temperature.

When the toner particles are prepared by emulsion aggregation, the RD/TD value of the toner particles may be adjusted within the range described above by adjusting a first heating rate in the aggregating process, circularity of the toner particles, or a type and amount of the external additive added to the toner particles.

For example, when the toner particles are prepared by emulsion aggregation, the RD/RD value of the toner particles may be adjusted such that after adding an agglomerating agent to a mixture of a latex, a colorant dispersion, and a wax dispersion and homogenizing the resultant mixture, a heating rate of a first heating process in an aggregating process may be adjusted to 0.2° C./min to 1.0° C./min,. By adjusting the heating rate as described above, inner pore size of produced toner particles may vary.

In addition, the circularity of the toner particles may be in the range of 0.960 to 0.975. When the circularity of the toner particles is within these ranges, the RD/TD value of the toner particles may be adjusted within the range described above.

In general, the external additive is used to improve flowability of toner or adjust charging properties thereof, and examples thereof include large particle-sized silica, small particle-sized silica, a polymer bead, and titanium oxide. In particular, small particle-sized silica and titanium oxide may be used so that the RD/TD value of the toner particles may be easily adjusted within the range described above.

According to another embodiment of the present invention, there is provided a developer for forming an electrostatic charge image which includes the toner particles. The developer may further include at least one carrier selected from the group consisting of ferrite coated with an insulating material, magnetite coated with an insulating material, and iron powder coated with an insulating material. In particular, ferrite or magnetite coated with an insulating material may be used.

According to another embodiment of the present invention, there is provided a method of forming an electrophotographic image by using the toner particles.

In particular, the method includes adhering the toner or the developer to a surface of a photosensitizer on which an electrostatic latent image is formed to form a toner image and transferring the toner image to a transfer member.

The toner particles or the developer may be used in an electrophotographic image forming apparatus, and examples of the electrophotographic image forming apparatus include laser printers, copy machines, and facsimile machines.

One or more embodiment of the present invention will now be described in further detail with reference to the following examples. These examples are for illustrative purposes only and are not intended to limit the scope of the invention.

Average Particle Diameter Measurement

The average particle diameter of toner particles was measured using a Coulter multisizer (Multisizer 3 Coulter Counter). The Coulter multisizer having an aperture of 100 μm was used. An appropriate amount of a surfactant was added to 50 to 100 ml of ISOTON-II (available from Beckman Coulter) as an electrolytic solution, 10 to 15 mg of a measurement sample was added thereto, and the resultant product was dispersed using an ultrasonic processor for 5 minutes, thereby completing the preparation of the sample.

Glass Transition Temperature (Tg, ° C.) Measurement

The glass transition temperature of a sample was measured by using a differential scanning calorimetry (product of Perkin Elmer) as follows: a sample was heated from 20° C. up to 200° C. at a heating rate of 10° C./min, and then quickly cooled to 10° C. at a cooling rate of 20° C./min, and then heated again at a heating rate of 10° C./min.

Circularity Measurement

Circularity was evaluated using FPIA-3000 (product of SYSMEX Company). A sample was previously treated by filling a 20 ml vial with 15 ml of distilled water , and adding 5 to 10 mg of a toner sample with an externally added additive thereto.

Subsequently, three to five droplets of a neutral surfactant were dropped thereto, and the resultant mixture was treated with ultrasonic waves in a sonicator for 30 minutes to disperse toner particles included therein. Then, 7 to 10 ml of the previously treated sample was added to a sample inlet of FPIA-3000, and circularity of the resulting toner sample was then measured. In this regard, the number of toner particles measured was 3,000. An average value of the circularity values of the measured 3,000 toner particles was recorded.

RD Measurement

The true density of a sample (2.7372 g) was measured using a gas type pycnometer (AccuPyc II 1340, Micrometrics) by using a helium gas, which is an inert gas. The temperature of the measured sample was maintained at 28.6° C., and an average value of the true density values measured five times of the sample was recorded.

TD Measurement

The TD of a sample was measured using Tapdenser KYT-4000 (available from Seishin). 10 g of a toner sample was loaded on a sieve having an aperture of 355 μm, a feeder level for supplying the sample was set at 9, and tapping was performed on the sample at a rate of 1.67 times/sec for 1 minute. After the tapping process, the TD of the toner sample was obtained by measuring the volume (cm³) of a toner included in a 150 ml vessel.

### Example 1

(Preparation of Latex for Core and Shell)

A 3 L reactor including a stirrer, a thermometer, and a condenser was placed in an oil bath. Subsequently, 660 g of distilled water and 3.2 g of a surfactant (Dowfax 2A1) were put in the reactor, the temperature of the reactor was raised up to 70° C., and the resultant product was stirred at 100 rpm. Then, an emulsion mixture of 838 g of styrene, 322 g of butyl acrylate, 37 g of 2-carboxylethyl acrylate, 22.6 g of 1,10-decandiol diacrylate as a monomer, 507.5 g of distilled water, 22.6 g of the surfactant (Dowfax 2A1), 53 g of polyethyleneglycol ethylether methacrylate, and 18.8 g of 1-dodecanthiol as a chain transfer agent was stirred using a disk-type impeller at 400 to 500 rpm for 30 minutes, and then slowly added to the reactor for 1 hour. Thereafter, the resultant mixture was maintained for about 8 hours to induce a reaction therebetween and then slowly cooled down to room temperature, thereby completing the reaction.

After the reaction was completed, a glass transition temperature Tg of the obtained binder resin was measured using a differential scanning calorimetry (DSC). As a result of the measurement, the Tg of the binder resin was 60 to 62° C.

(Preparation of Pigment Dispersion)

540 g of a cyan pigment (ECB303, Daicolor Pigment Mfg. Co., Ltd product), 27 g of a surfactant (Dowfax 2A1), and 2,450 g of distilled water were added to a 3 L reactor including a stirrer, a thermometer, and a condenser, and then the mixture was preliminary dispersed by slowly stirring for about 10 hours. Then, dispersing was performed thereon using an ultimaizer for 4 hours to obtain a cyan pigment dispersion.

After the dispersion was completed, the particle diameter of the obtained cyan pigment particles was measured using multisizer 2000 (available from Malvern). As a result of the measurement, the particle diameter D50(v) thereof was 170 nm. In this regard, D50(v) refers to a particle diameter corresponding to 50% based on a volume average particle diameter, i.e., a particle diameter corresponding to 50% of the total volume when particle diameters are measured and the volume of particles is accumulated from smaller particles.

(Preparation of Wax Dispersion)

65 g of a surfactant (Dowfax 2A1) and 1,935 g of distilled water were added to a 5 L reactor including a stirrer, a thermometer, and a condenser. Subsequently, while the mixed solution was being slowly stirred at a high temperature for about 2 hours, 1,000 g of wax (NOF, Japan, WE-5) was added to the reactor. The resultant solution was dispersed using a homogenizer (IKA, T-45) for 30 minutes. As a result, a wax dispersion was obtained.

After the dispersing process was completed, the particle diameter of dispersed wax particles was measured using multisizer 2000 (available from Malvern). As a result of the measurement, the particle diameter D50(v) thereof was 320 nm.

(Preparation of Toner Particles)

8.4 kg of the latex for core, 0.7 kg of the pigment dispersion, and 1.4 kg of the wax dispersion were added to a 20 L reactor and then mixed together at 50 rpm and room temperature for 15 hours. Subsequently, 0.14 to 0.7 kg of a mixed solution of poly silicato iron (PSI) as an aggregating agent and nitric acid (PSI/1.88% HNO₃=½) was added thereto, and high-speed homogenization was performed using a homogenizer (IKA, T-50) while the resultant solution was being mixed at 50 rpm (stirring linear velocity: 1.79 m/sec), a temperature of 25° C. and a pH of 1.3 to 2.3 for 30 minutes. Afterwards, the temperature of the reactor was raised to 51.5° C. and the resulting solution was stirred at 100 to 200 rpm to perform aggregation therebetween. The aggregation was continuously performed until an average particle diameter of particles included in the resulting solution reached 6.3 to 6.4 μm, and 3.5 kg of the latex for shell was then added thereto for about 20 minutes. The resultant solution was continuously stirred until the average particle diameter therein reached 6.7 to 6.9 μm, 4% aqueous sodium hydroxide solution was then added to the reactor, and the resultant solution was further stirred at 50 to 150 rpm until pH thereof reached 7. While the stirring speed was maintained, the temperature of the reactor was raised to 95.5° C. to fuse toner particles. If the circularity of the toner particles measured using FPIA-3000 (available from sysmex) was 0.960 to 0.975, the temperature of the reactor was cooled to 40° C., pH thereof was adjusted to 9.0, and a toner was separated from the resultant solution by using a Nylon mesh having a pore size of 16 μm. Then, the separated toner was washed four times with distilled water, and the resultant toner was washed after pH thereof was adjusted to 1.5 by using a 1.88% nitric acid aqueous solution and further washed four times with distilled water to remove the unnecessary materials including the surfactant, and the like therefrom. Thereafter, toner particles obtained after the washing process was completed were dried in a fluidized bed dryer at 40° C. for 5 hours to obtain dried toner particles. After the drying process, an external addition process was performed. The external addition process was performed using a Powder mixer (2 L, DAE WHA TECH.). The external addition conditions were as follows: at 8,000 rpm for 2 minutes; maintained for 10 seconds; and at 8,000 rpm for 2 minutes, thereby completing the external addition process. Afterwards, the toner was sorted using a sieve having an aperture of 150 μm.

Toner parent particles were prepared using the method described above and external additives including 1.0 wt % of small particle-sized silica (R8200, available from Aerosil), 0.3 wt % of large particle-sized silica (RY50, available from Aerosil), 0.3 wt % of MP1451 as a polymer bead (manufactured by Soken), and 0.5 wt % of titanium oxide (T-805, available from Aerosil) were externally added thereto, thereby completing the preparation of a toner.

### Example 2

Toner particles were prepared in the same manner as in Example 1, except that 1.0 wt % of X20 (manufactured by Tokuyama) was used as small particle-sized silica instead of R8200 in the external addition process.

### Example 3

Toner particles were prepared in the same manner as in Example 1, except that 1.0 wt % of RX300 (manufactured by Aerosil) was used as small particle-sized silica instead of R8200 in the external addition process.

### Example 4

Toner particles are prepared in the same manner as in Example 1, except that the amount of R8200 used as small particle-sized silica in the external addition process was adjusted to 0.5 wt % from the 1.0 wt %.

### Example 5

Toner particles are prepared in the same manner as in Example 1, except that the amount of R8200 used as small particle-sized silica in the external addition process was adjusted to 0.2 wt % from the 1.0 wt %.

### Example 6

Toner particles were prepared in the same manner as in Example 1, except that the circularity of the toner particles was adjusted to 0.965 from 0.971 by shortening a fusing time in reaction processes, and aggregating and fusing temperatures shown in Table 1 below were used.

### Example 7

Toner particles were prepared in the same manner as in Example 1, except that the circularity of the toner particles was adjusted to 0.960 from 0.971 by shortening a fusing time in reaction processes, and aggregating and fusing temperatures shown in Table 1 below were used.

### Comparative Example 1

Toner particles were prepared in the same manner as in Example 1, except that the external addition process was not performed in the toner producing processes.

### Comparative Example 2

Toner particles were prepared in the same manner as in Example 1, except that the small particle-sized silica was not used in the external addition process.

### Comparative Example 3

Toner particles were prepared in the same manner as in Example 1, except that JMT150IB (manufactured by TAYCA) was used as titanium oxide instead of T805 in the external addition process.

Experimental results of the toner particles prepared according to Examples 1 through 7 and Comparative Examples 1 through 3 are shown in Table 1.

TABLE 1

| | Example | Example | Example | Example | Example | Example | Example | Comparative | Comparative | Comparative |
|---|---|---|---|---|---|---|---|---|---|---|
| | 1 | 2 | 3 | 4 | 5 | 6 | 7 | Example 1 | Example 2 | Example 3 |
| Aggregating | 51.5 | 51.5 | 51.5 | 51.5 | 51.5 | 52.0 | 52.0 | 51.5 | 51.5 | 51.5 |
| temperature | | | | | | | | | | |
| (□) | | | | | | | | | | |
| pH for | 7 | 7 | 7 | 7 | 7 | 7 | 7 | 7 | 7 | 7 |
| freezing | | | | | | | | | | |
| aggregation | | | | | | | | | | |
| Fusing | 95.5 | 95.5 | 95.5 | 95.5 | 95.5 | 96.0 | 96.0 | 95.5 | 95.5 | 95.5 |
| temperature | | | | | | | | | | |
| (□) | | | | | | | | | | |
| Fusing time | 5 | 5 | 5 | 5 | 5 | 4 | 3 | 5 | 5 | 5 |
| (hrs) | | | | | | | | | | |
| Composition | R8200 | X20 | RX300 | R8200 | R8200 | R8200 | R8200 | external | RY50 | R8200 |
| of external | 1 wt %, | 1 wt %, | 1 wt %, | 0.5 wt %, | 0.2 wt %, | 1 wt %, | 1 wt %, | addition | 0.3 wt %, | 1 wt %, |
| additives | RY50 | RY50 | RY50 | RY50 | RY50 | RY50 | RY50 | process | MP1451 | RY50 |
| | 0.3 wt % | 0.3 wt %, | 0.3 wt %, | 0.3 wt %, | 0.3 wt %, | 0.3 wt %, | 0.3 wt %, | was not | 0.3 wt %, | 0.3 wt %, |
| | MP1451 | MP1451 | MP1451 | MP1451 | MP1451 | MP1451 | MP1451 | performed | T805 | MP1451 |
| | 0.3 wt % | 0.3 wt %, | 0.3 wt %, | 0.3 wt %, | 0.3 wt %, | 0.3 wt %, | 0.3 wt %, | | 0.5 wt % | 0.3 wt %, |
| | T805 | T805 | T805 | T805 | T805 | T805 | T805 | | | JMT150IB |
| | 0.5 wt % | 0.5 wt % | 0.5 wt % | 0.5 wt % | 0.5 wt % | 0.5 wt % | 0.5 wt % | | | 0.5 wt % |

The properties of the toner particles of Examples 1 through 7 and Comparative Examples 1 through 3 were evaluated as follows.

Cohesiveness

The cohesiveness of the toner obtained after the external addition process was measured using a powder tester (manufactured by Hosokawa micron). Meshes having apertures of 53 μm, 45 μm, and 38 μm, respectively, were used in the measurement of the cohesiveness thereof. At initial measurement, 2 g of the toner was weighed and loaded on a mesh having an aperture of 53 μm, and the cohesiveness thereof was measured for 40 seconds with vibration dial 1. After vibration process was completed, the weights of the three meshes were measured to measure the amount of the toner remaining on the meshes. After the measurement, the cohesiveness of the toner was calculated using the following equation:

Cohesiveness (%)={(weight of toner powder remaining on upper sieve)/2}×100×(⅕)+{(weight of toner powder remaining on middle sieve)/2}×100×(⅗)+{(weight of toner power remaining on lower sieve)/2}×100×(⅕)

Background Properties

Background properties of the prepared toner were evaluated as follows: a laser printer was stopped during printing of a full size white image, a magic tape (width: 19 mm, manufactured by 3M) was adhered to an organic photosensitive drum and then removed therefrom, the magic tape was adhered to paper, and the optical density of the toner was measured using a SpectroEye (manufactured by Macbeth). In this regard, a Samsung CLP-600 color laser printer was used for image printing.

Scattering Properties

Scattering properties of the prepared toner were observed with the naked eye, and experimental results of the toner particles of Examples 1 to 7 and Comparative Examples 1 to 3 were shown in Table 2 below. A cartridge of a laser printer was filled with each toner sample, 20 sheets of reference chart (QEA chart) were printed, the laser printer was opened, and the scattering of each toner to the outside of the cartridge was then observed. The scattering properties of the toner were represented by ⊚, ◯, X, and each symbol has the following meaning.

⊚: No scattering of toner

◯: Little scattering of toner, No problem

X : Severe scattering of toner

Evenness

Evenness refers to evenness of the optical density. Reference sample charts were printed, and then optical densities of central, right and left parts of the printed image were measured using a SpectroEye (manufactured by Macbeth). When the optical densities of the central, right and left parts of the printed image were denoted as ODc, ODR, and ODL, respectively, the evenness was obtained by the following equation:

Evenness=|ODc−ODR|+|ODc−ODL|

The evaluation results are shown in Table 2 below.

TABLE 2

| | Example | Example | Example | Example | Example | Example | Example | Comparative | Comparative | Comparative |
|---|---|---|---|---|---|---|---|---|---|---|
| | 1 | 2 | 3 | 4 | 5 | 6 | 7 | Example 1 | Example 2 | Example 3 |
| Average particle | 6.92 | 6.89 | 6.88 | 6.90 | 6.87 | 6.75 | 6.77 | 6.88 | 6.91 | 6.90 |
| diameter (μm) | | | | | | | | | | |
| Circularity | 0.971 | 0.971 | 0.971 | 0.971 | 0.971 | 0.965 | 0.960 | 0.971 | 0.971 | 0.971 |
| Cohesiveness (%) | 9.2 | 8.7 | 6.5 | 14.7 | 25.2 | 9.7 | 9.1 | 63.4 | 37.5 | 3.8 |
| RD (g/cm³) | 1.0990 | 1.0991 | 1.0989 | 1.0987 | 1.0988 | 1.0989 | 1.0990 | 1.0989 | 1.0990 | 1.0988 |
| TD (g/cm³) | 0.5165 | 0.5279 | 0.5412 | 0.4651 | 0.4402 | 0.5110 | 0.5190 | 0.4105 | 0.4255 | 0.5601 |
| RD/TD | 2.1278 | 2.0820 | 2.0305 | 2.3623 | 2.4961 | 2.1505 | 2.1175 | 2.6770 | 2.5828 | 1.9618 |
| Background | 0.050 | 0.051 | 0.042 | 0.060 | 0.059 | 0.061 | 0.052 | 0.058 | 0.061 | 0.115 |
| properties | | | | | | | | | | |
| Scattering | ◯ | ⊚ | ◯ | ⊚ | ⊚ | ◯ | ◯ | ⊚ | ⊚ | X |
| properties | | | | | | | | | | |
| Evenness | 0.09 | 0.13 | 0.09 | 0.13 | 0.15 | 0.10 | 0.09 | 0.43 | 0.35 | 0.03 |
| BET Surface | 100 | 85 | 190 | 100 | 100 | 100 | 100 | — | 40 | 220 |
| area (external | | | | | | | | | | |
| additive) | | | | | | | | | | |

As shown in Table 2, the toner particles of Examples 1 through 7 have excellent scattering properties, cohesiveness and evenness.

1. Toner particles for developing an electrostatic charge image, the toner particles comprising a binder resin, a releasing agent, a colorant, and an external additive, wherein the toner particles satisfy expression (1):
2.0≦RD/TD2.5 (1),
wherein RD is the real density of the toner particles and TD is the tap density of the toner particles.

2. The toner particles of claim 1, wherein the toner particles have a TD of 0.43 to 0.55 g/cm³.

3. The toner particles of claim 1, wherein the toner particles have a circularity of 0.960 to 0.975.

4. The toner particles of claim 1, wherein the external additive is titanium oxide and small particle-sized silica.

5. The toner particles of claim 4, wherein an amount of the external additive is in a range of 0.1 to 3.0 wt %.

6. The toner particles of claim 4, wherein the external additive has a BET surface area ranging from 30 to 230 m²/g.

7. The toner particles of claim 1, wherein the toner particles has a cohesiveness of 6.5% to 25.2%.

8. A developer for forming an electrostatic charge image, the developer comprising the toner particles according to claim 1.

9. The developer of claim 8, further comprising at least one carrier selected from the group consisting of ferrite coated with an insulating material, magnetite coated with an insulating material, and iron powder coated with an insulating material.

10. A method of forming an electrophotographic image, the method comprising adhering a toner to a surface of a photosensitizer on which an electrostatic latent image is formed to form a toner image and transferring the toner image to a transfer member, wherein the toner comprises the toner particles according to claim 1.
